(19) United States
(12) Patent Application Publication
(10) Pub. No.: US 2017/0038908 A1
(43) Pub. Date: Feb. 9, 2017

(54) TOUCH DISPLAY DRIVE METHOD, DRIVE DEVICE AND TOUCH DISPLAY

(71) Applicant: Boe Technology Group Co., Ltd., Beijing (CN)

(72) Inventors: Xiangxiang Zou, Beijing (CN); Jiayang Zhao, Beijing (CN)

(21) Appl. No.: 14/917,370

(22) PCT Filed: Aug. 20, 2015
(86) PCT No.: PCT/CN15/87691

§ 371 Date: Mar. 8, 2016

(30) Foreign Application Priority Data
Mar. 31, 2015 (CN) 201510146434.7

(51) Int. Cl. G06F 3/041

(52) U.S. Cl. CPC G06F 3/0418; G06F 3/0412

(57) ABSTRACT

A touch display drive method, a drive device and a touch display in the field of display technologies. The touch display drive method comprises inputting a display drive signal and a touch scanning signal to an electrode array While the display drive signal is being input, the touch scanning signal is input for touch scanning. Each touch scanning signal line for inputting the touch scanning signal generates a coupling signal for electrodes in the same column, and two coupling signals generated by two of touch scanning signal lines in the same column offset each other. The method solves problems with the display and touch control caused by insufficient time due to time-division driving.

### CROSS-REFERENCE TO THE RELATED APPLICATIONS

The present application is the U.S. national phase entry of PCT/CN2015/087691, with an international filing date of Aug. 20, 2015, which claims the benefit of Chinese Patent Application No. 201510146434.7, filed on Mar. 31, 2015, the entire disclosures of which are incorporated herein by reference.

### TECHNICAL FIELD

The present disclosure relates to the field of display technologies, and particularly to a touch display drive method, a drive device and a touch display.

### BACKGROUND

As the touch control technology develops constantly, more and more various display products have a touch control function. Among various touch control technologies, the in-cell touch control technology has gradually drawn attention of more and more people due to its advantages, such as a low cost and a small thickness.

In an in-cell touch display panel, a common electrode located in a substrate on a display light-exit side is not only used to drive liquid crystals to deflect, but also serves as a touch electrode to achieve a touch control function. To prevent interference caused by simultaneous input of a display signal and a touch scanning signal into the electrode from affecting the normal display or touch control function, current in-cell touch displays employ time-division driving. For example, display driving is performed in a time period within a frame period, and touch driving in another time period, thereby preventing the interference between the display signal and touch scanning signal from affecting the display effect or touch control effect. However, a drawback is that in a high-resolution display touch products, employment of the time-division driving causes insufficient drive time or an unduly long scanning interval, which will incur various problems, such as decrease of a display refresh rate or reduction of touch control precision.

### SUMMARY

In view of the problems with display and touch control caused by insufficient time due to the time-division driving, the present disclosure provides a touch display drive method, a drive device and a touch display.

According to an aspect of the present disclosure, a touch display drive method is provided, comprising:

inputting a display drive signal and a touch scanning signal to an electrode array, the electrode array comprising at least one first electrode region and at least one second electrode region, each of the first electrode region and second electrode region comprising a plurality of columns of electrodes, and each electrode in the plurality of columns of electrodes being provided with the display drive signal or touch scanning signal via a respective signal line in a column direction,

wherein the touch scanning signal is input to said at least one second electrode region for touch scanning while the display drive signal is being input to said at least one first electrode region for display driving, each of touch scanning signal lines providing the touch scanning signal generating a coupling signal for electrodes in the same column other than the electrode to which the touch scanning signal is provided via the touch scanning signal line, and two coupling signals generated by two of said touch scanning signal lines in the same column offsetting each other; and

wherein the touch scanning signal is input to said at least one first electrode region for touch scanning while the display drive signal is being input to said at least one second electrode region for display driving, each of touch scanning signal lines providing the touch scanning signal generating a coupling signal for electrodes in the same column other than the electrode to which the touch scanning signal is provided via the touch scanning signal line, and two coupling signals generated by two of said touch scanning signal lines in the same column offsetting each other.

According to another aspect of the present disclosure, a touch display drive device is provided, comprising a control unit, the control unit configured to:

input a display drive signal and a touch scanning signal to an electrode array, the electrode array comprising at least one first electrode region and at least one second electrode region, each of the first electrode region and second electrode region comprising a plurality of columns of electrodes, and each electrode in the plurality of columns of electrodes being provided with the display drive signal or touch scanning signal via a respective signal line in a column direction,

wherein the control unit inputs the touch scanning signal to said at least one second electrode region for touch scanning while inputting the display drive signal to said at least one first electrode region for display driving, each of touch scanning signal lines providing the touch scanning signal generating a coupling signal for electrodes in the same column other than the electrode to which the touch scanning signal is provided via the touch scanning signal line, two coupling signals generated by two of said touch scanning signal lines in the same column offsetting each other; and

wherein the control unit inputs the touch scanning signal to said at least one first electrode region for touch scanning while inputting the display drive signal to said at least one second electrode region for display driving, each of touch scanning signal lines providing the touch scanning signal generating a coupling signal for electrodes in the same column other than an electrode to which the touch scanning signal is provided via the touch scanning signal line, two coupling signals generated by two of said touch scanning signal lines in the same column offsetting each other.

According to a further aspect of the present disclosure, a touch display is provided, comprising: a first substrate and a second substrate formed by cell-assembling, the first substrate being provided with an electrode array; and a touch display drive device as described above, the touch display drive device being electrically connected with each electrode in the electrode array respectively via a respective metallic wire.

The concept of the present disclosure lies in that the touch scanning signal is inputted to the second electrode region for touch scanning while the display drive signal is being inputted to the first electrode region of the electrode array for display driving, and that in the second electrode region, coupling effects of two touch scanning signals in the same column on at least the first electrode region offset each other, or vice versa. As such, driving the in-cell touch display structure on a region basis achieves an effect of driving display and touch control at the same time, solves problems with the display and touch control caused by insufficient time due to time-division driving in a high resolution application, and effectively avoids impact exerted by noise resulting from the signal coupling of the touch electrode to the display and touch control effect.

### BRIEF DESCRIPTION OF THE DRAWINGS

To make technical solutions in embodiments of the present disclosure more apparent, figures used in depictions of the embodiments will be introduced briefly. The figures in the following depictions are only some embodiments of the present disclosure, and those having ordinary skill in the art appreciate that other figures may be obtained on the basis of these figures without making any inventive efforts.

FIG. 1 is a flow chart of a touch display drive method according to an embodiment of the present disclosure;

FIG. 2 is a structural schematic view of a touch display drive device according to an embodiment of the present disclosure;

FIG. 3 is a structural schematic view of a substrate of a touch display according to an embodiment of the present disclosure;

FIG. 4 is a graph of a drive signal waveform for the substrate shown in FIG. 3;

FIG. 5 is a schematic diagram showing the coupling of the signal as shown in FIG. 4;

FIG. 6 is a structural schematic view of a substrate of another touch display according to an embodiment of the present disclosure;

FIG. 7 is a graph of a drive signal waveform for the substrate shown in FIG. 6;

FIG. 8 is a schematic diagram showing the coupling of the signal as shown in FIG. 7;

FIG. 9 is a sectional view of a substrate of a touch display according to an embodiment of the present disclosure;

FIG. 10a is a structural schematic view of an electrode connection metal wire in a touch display according to an embodiment of the present disclosure; and

FIG. 10b is a structural schematic view of another electrode connection metal wire in a touch display according to an embodiment of the present disclosure.

### DETAILED DESCRIPTION

To make objectives, technical solutions, and advantages of the present disclosure more apparent, embodiments of the present disclosure will be described in detail with reference to the figures.

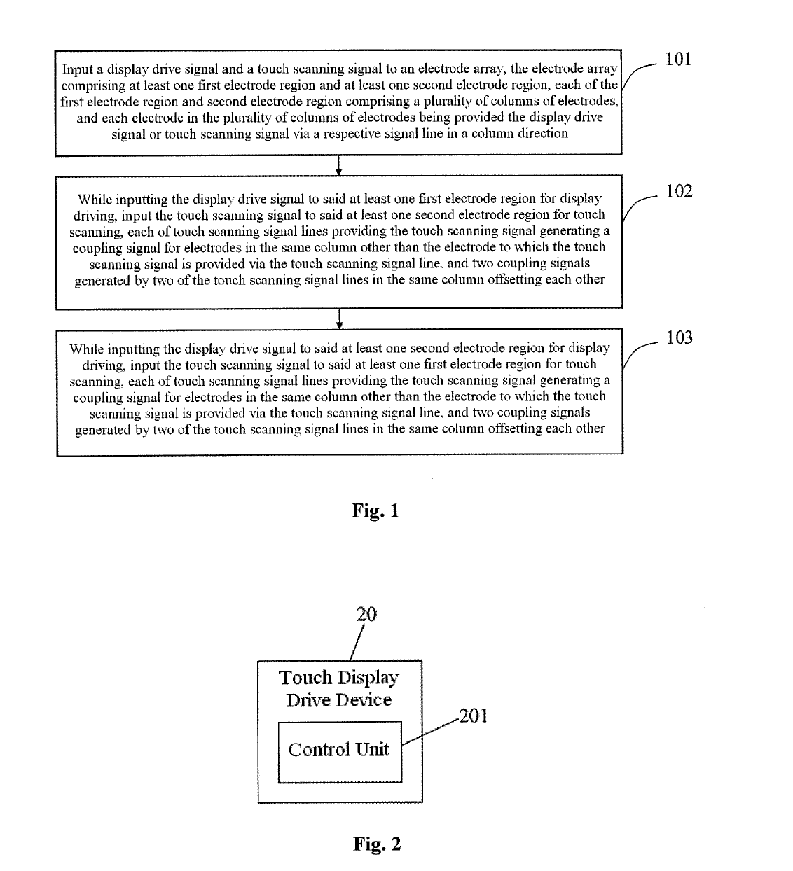

FIG. 1 is a flow chart of a touch display drive method according to an embodiment of the present disclosure. The touch display drive method comprises the following steps:

Step 101: inputting a display drive signal and a touch scanning signal to an electrode array, the electrode array comprising at least one first electrode region and at least one second electrode region, each of the first electrode region and second electrode region comprising a plurality of columns of electrodes, and each electrode in the plurality of columns of electrodes being provided the display drive signal or touch scanning signal via a respective signal line in the column direction.

Step 102: While inputting the display drive signal to said at least one first electrode region for display driving, inputting the touch scanning signal to said at least one second electrode region for touch scanning, each of touch scanning signal lines providing the touch scanning signal generating a coupling signal for electrodes in the same column other than the electrode to which the touch scanning signal is provided via the touch scanning signal line, two coupling signals generated by two of said touch scanning signal lines in the same column offsetting each other. More specifically, the touch scanning signals provided by the two touch scanning signal lines may be signals with the same amplitude and different (in some embodiments, opposite) phases. In the case of different phases, the coupling effect of the two touch scanning signals at least partially offset. In the case of opposite phases, the coupling effect of the two touch scanning signals completely offset.

Step 103: While inputting the display drive signal to said at least one second electrode region for display driving, inputting the touch scanning signal to said at least one first electrode region for touch scanning, each of touch scanning signal lines providing the touch scanning signal generating a coupling signal for electrodes in the same column other than the electrode to which the touch scanning signal is provided via the touch scanning signal line, two coupling signals generated by two of said touch scanning signal lines in the same column offsetting each other. As stated above, the touch scanning signals provided by the two touch scanning signal lines may be signals with the same amplitude and different (in some embodiments, opposite) phases.

It is to be noted that in embodiments of the present disclosure, division of the electrode region is not limited to the above-depicted situation, but may be selected as appropriate. For example, the electrode region may be divided according to a TP (Touch Panel) report rate. Moreover, in embodiments of the present disclosure, the electrode array refers to a plurality of electrodes arranged in a matrix, and the electrode array includes multiple rows and multiple columns of electrodes. More specifically, such electrodes may be common electrodes in the in-cell touch display panel.

In embodiments of the present disclosure, driving the in-cell touch display structure on a region basis achieves an effect of driving display and touch control at the same time, and solves problems with the display and touch control caused by insufficient time due to time-division driving in a high resolution application. When the touch scanning signal is inputted to a certain electrode via a touch scanning signal line, the touch scanning signal line generates a coupling signal to electrodes in the same column other than the electrode, and two coupling signals generated by two touch scanning signal lines in the same column offset each other, thereby effectively avoiding impact exerted by noises resulting from the signal coupling of the touch electrode to the display and touch effect.

Furthermore, the electrode region may comprise at least one sub-region, each sub-region comprising two adjacent rows of electrodes. The step of inputting the touch scanning signal to the electrode region for touch scanning may comprise: inputting touch scanning signal with the same amplitude and different (in some embodiments, opposite) phases to two electrodes in each column in each sub-region of the electrode region.

It should be appreciated that the amplitude of the touch scanning signal refers to the maximum amplitude of the signal waveform, and the phase of the touch scanning signal may refer to a state where the touch scanning signal is at a high level or zero level at a given time. For example, in embodiments of the present disclosure, the touch scanning signal may take the form of a square wave signal whose amplitude may be 5 v. The touch scanning signals of +5 v and of 0 v may be input respectively to two rows of electrodes in each sub-region in the electrode region at the same moment. It should be appreciated that the level values +5 v and 0 v are only for purposes of illustration, and that other level values may be selected in an actual application.

As such, in each sub-region, the coupling effects of the two rows of electrodes on the electrode region into which the display drive signal is input are opposite and thus offset each other. This effectively avoids the interference caused by noises resulting from the signal coupling of the touch region electrode to the display signal and avoids an impact to the display effect.

Alternatively, the electrode region may also comprise at least one sub-region, each sub-region comprising three adjacent rows of electrodes. The step of inputting the touch scanning signal to the electrode region for touch scanning may comprise: inputting the touch scanning signal to one of three electrodes in each column in each sub-region in the electrode region, while inputting touch scanning signals with the same amplitude and different (in some embodiments, opposite) phases respectively to the remaining two electrodes.

As such, in each sub-region, the coupling effects of the touch scanning signals of the two rows of electrodes on an input signal of the remaining one row of electrode are opposite and offset each other. Thus, an impact on the touch performance caused by noises resulting from the signal coupling of other electrodes in the touch region can be avoided, and the touch performance can be improved. In addition, the coupling effects of the two touch scanning signals on the electrode region into which the display drive signal is input also offset each other.

FIG. 2 is a structural schematic view of a touch display drive device according to an embodiment of the present disclosure. The touch display drive device 20 comprises a control unit 201 which is used to input the display drive signal and touch scanning signal to the electrode array, wherein the electrode array comprises at least one first electrode region and at least one second electrode region. Each of the first electrode region and second electrode region comprises a plurality of columns of electrodes, and each electrode in the plurality of columns of electrodes is provided with the display drive signal or touch scanning signal via a respective signal line in a column direction.

While inputting the display drive signal to the at least one first electrode region for display driving, the control unit 201 inputs the touch scanning signal to the at least one second electrode region for touch scanning. Each of the touch scanning signal lines providing the touch scanning signal generates a coupling signal for electrodes in the same column other than an electrode to which the touch scanning signal is provided via the touch scanning signal line, and two coupling signals generated by two of the touch scanning signal lines in the same column offset each other. As stated above, the touch scanning signals input via the two touch scanning signal lines may be signals with the same amplitude and different (in some embodiments, opposite) phases.

While inputting the display drive signal to the at least one second electrode region for display driving, the control unit 201 inputs the touch scanning signal to the at least one first electrode region for touch scanning. Each of the touch scanning signal lines providing the touch scanning signal generates a coupling signal for electrodes in the same column other than an electrode to which the touch scanning signal is provided via the touch scanning signal line, and two coupling signals generated by two of the touch scanning signal lines in the same column offset each other. As stated above, the touch scanning signals input via the two touch scanning signal lines may be signals with the same amplitude and different (in some embodiments, opposite) phases.

Driving the in-cell touch display structure on a region basis achieves an effect of driving display and touch control at the same time, and solves problems with the display and touch control caused by insufficient time due to time-division driving in a high resolution application. When the touch scanning signal is inputted to a certain electrode via a touch scanning signal line, the touch scanning signal line generates a coupling signal to electrodes in the same column other than the electrode, and two coupling signals generated by two of the touch scanning signal lines in the same column offset each other, thereby effectively avoiding an impact exerted by noises resulting from the signal coupling of the touch electrode to the display touch effect.

Furthermore, the electrode region may comprise at least one sub-region, each sub-region comprising two adjacent rows of electrodes. In this case, the control unit 201 may be configured to input touch scanning signals with the same amplitude and different (in some embodiments, opposite) phases to two electrodes in each column in each sub-region of the electrode region.

As such, in each sub-region, the coupling effects of the two rows of electrodes are opposite and offset each other. This effectively avoids the interference caused by noises resulting from the signal coupling of the touch region electrode to the display signal and avoids an impact to the display effect.

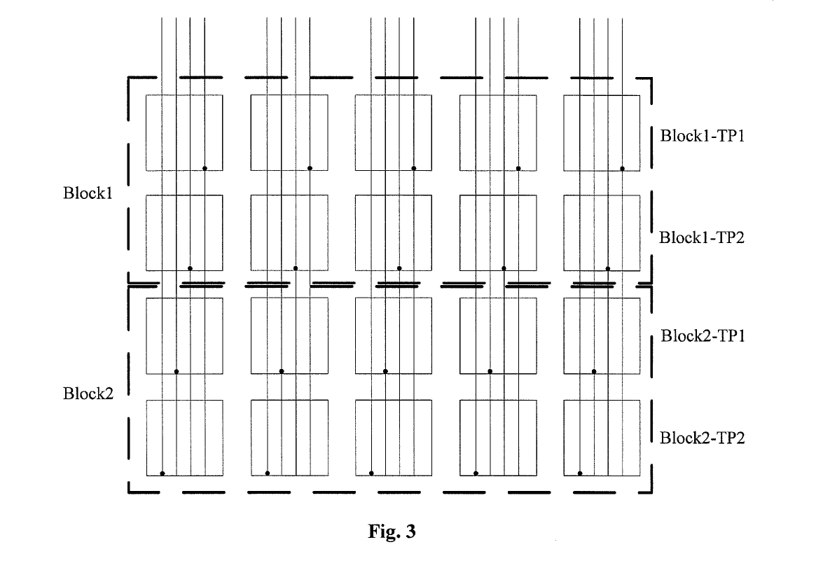

FIG. 3 is a schematic view of a substrate of a touch display according to an embodiment of the present disclosure. As shown in the figure, two sub-regions Block1 and Block2 respectively belong to the first electrode region and the second electrode region, each sub-region comprising two adjacent rows of electrodes TP1 and TP2. When Block1 performs display driving, Block2 performs touch driving. When Block2 performs display driving, Block 1 performs touch driving. This may ensure concurrent performance of the touch driving and display driving, and achieve frequencies of, for example, 60 Hz for display and 120 Hz for touch control.

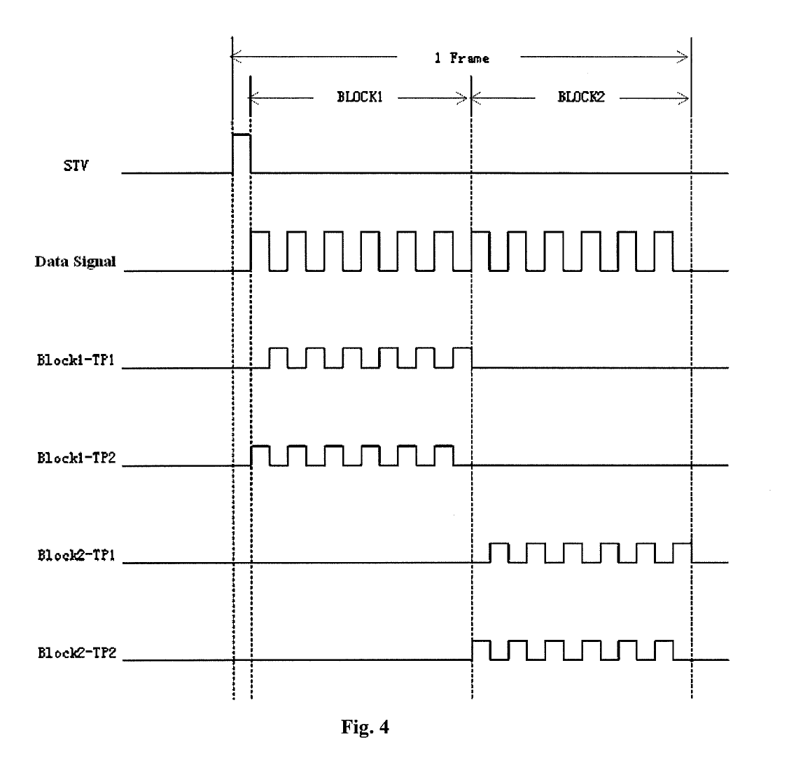

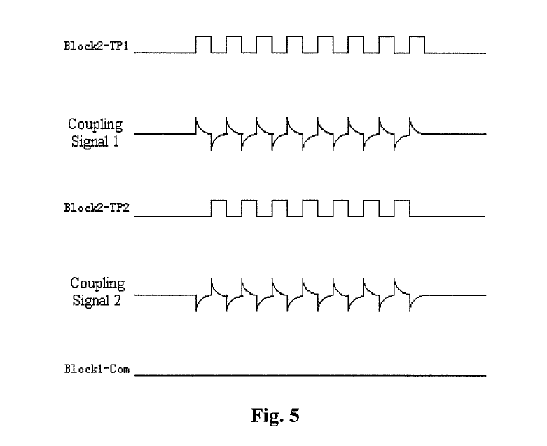

When Block1 performs the display driving, an electrode in Block1 is coupled to a common electrode signal (a DC signal), and meanwhile Block2 performs the touch driving. At this point, two rows of electrodes in Block2, Block2-TP1 and Block2-TP2, are respectively provided with signals with the same amplitude and different phases. The signal waveforms may be those as shown in FIG. 4. Thus, coupling effects of the metal wires of Block2-TP1 and Block2-TP2 on the common electrode signal in Block1 are opposite and offset each other, as shown in FIG. 5. As such, the impact on the display effect exerted by noises resulting from signal coupling of the touch electrode is effectively avoided.

Alternatively, the electrode region may also comprise at least one sub-region, each sub-region comprising three adjacent rows of electrodes. In this case, the control unit 201 may be configured to input the touch scanning signal to one of three electrodes in each column in each sub-region in the electrode region while inputting touch scanning signals with the same amplitude and different (in some embodiments, opposite) phases respectively to the remaining two electrodes.

As such, in each sub-region, the coupling effects of the touch scanning signals of the two rows of electrodes on an input signal line of the remaining one row of electrode are opposite and offset each other. This can effectively avoid an impact on the touch performance caused by the signal coupling of other electrodes in the touch region, and hence improve the touch performance.

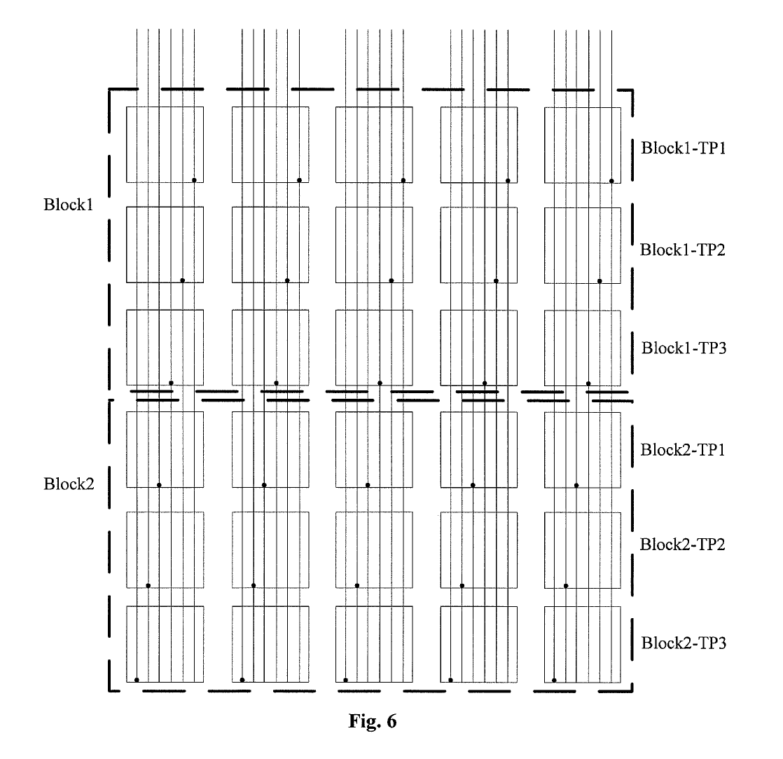

FIG. 6 is a structural schematic view of a substrate of another touch display according to an embodiment of the present disclosure. As shown in the figure, two sub-regions Block1 and Block2 belong to the first electrode region and the second electrode region, respectively, each sub-region comprising three adjacent rows of electrodes TP1, TP2 and TP3. When Block1 performs display driving, Block2 performs touch driving. When Block2 performs display driving, Block 1 performs touch driving. This may ensure concurrent performance of the touch drive and display drive, and achieve frequencies of, for example, 60 Hz for display and 120 Hz for touch control.

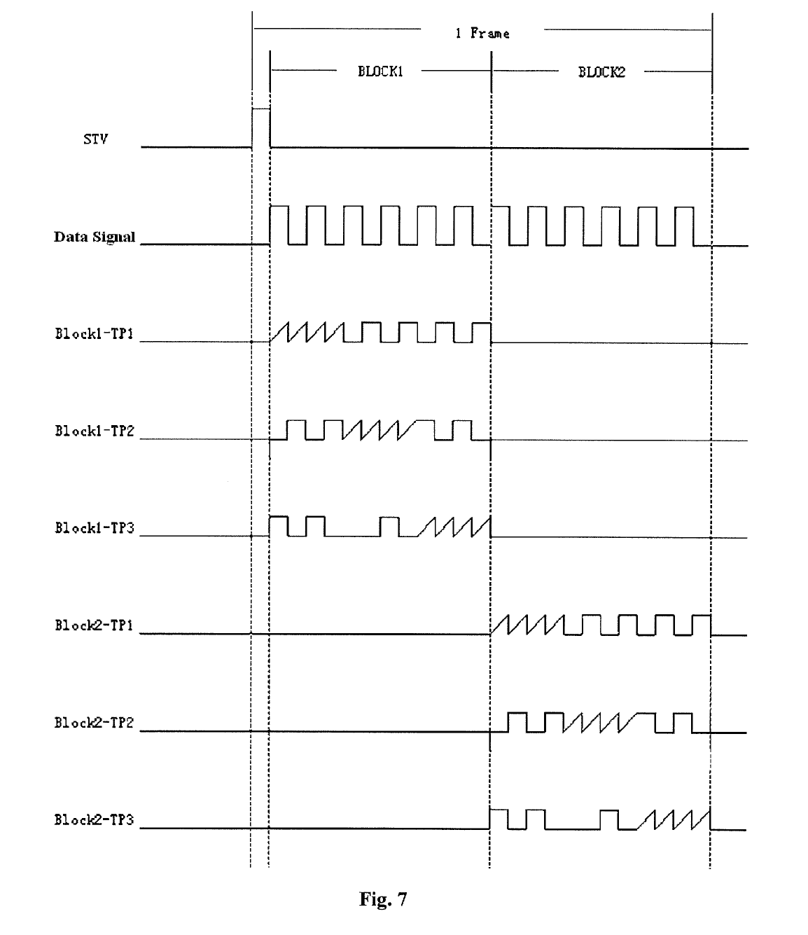

When Block1 performs the display driving, an electrode in Block1 is coupled to a common electrode signal (a DC signal), and meanwhile Block2 performs the touch driving. At the same time, when Block2-TP1 performs scanning of the touch scanning signal, touch scanning signals with the same amplitude and different (in some embodiments, opposite) phases are input to other electrodes such as Block2-TP2 and Block2-TP3. The three sets of signals are shown in FIG. 7. It is to be noted that in the signal waveforms as shown in FIG. 7, the touch scanning signal input to Block2-TP1 is purposefully represented in a sawtooth waveform to distinguish the touch scanning signal input to Block2-TP1 from the remaining two sets of signals and to better exhibit the relationship between the input signals of Block2-TP2 and Block2-TP3. However, this waveform is not a limitation to the type of the input signal. Coupling effects of the touch scanning signals of Block2-TP2 and Block2-TP3 on the touch scanning signal of Block2-TP1 are opposite and offset each other as shown in FIG. 8, thereby effectively avoiding an impact on the touch performance caused by the signal coupling of other electrodes, and hence improving the touch performance.

According to another aspect of the present disclosure, there is provided a touch display comprising a first substrate and a second substrate formed by cell-assembling, wherein the first substrate is provided with an electrode array. The touch display may be implemented as any product or component having a display function, such as a liquid crystal display, a mobile phone, a flat panel computer, a television set, a display, a notebook computer, a digital photo frame and a navigator.

The touch display further comprises any of the touch display drive device as described above. The touch display drive device is electrically connected with each electrode in the electrode array respectively via a respective metallic wire to input the touch scanning signal to the second electrode region for touch scanning while inputting the display drive signal to the first electrode region of the electrode array for display driving, such that in the second electrode region, coupling effects of two touch scanning signals in the same column on at least the first electrode region offset each other; or vice versa. The specific structure and function of the touch display drive device have already been described in detail in the aforesaid embodiments and will not be detailed here for simplicity.

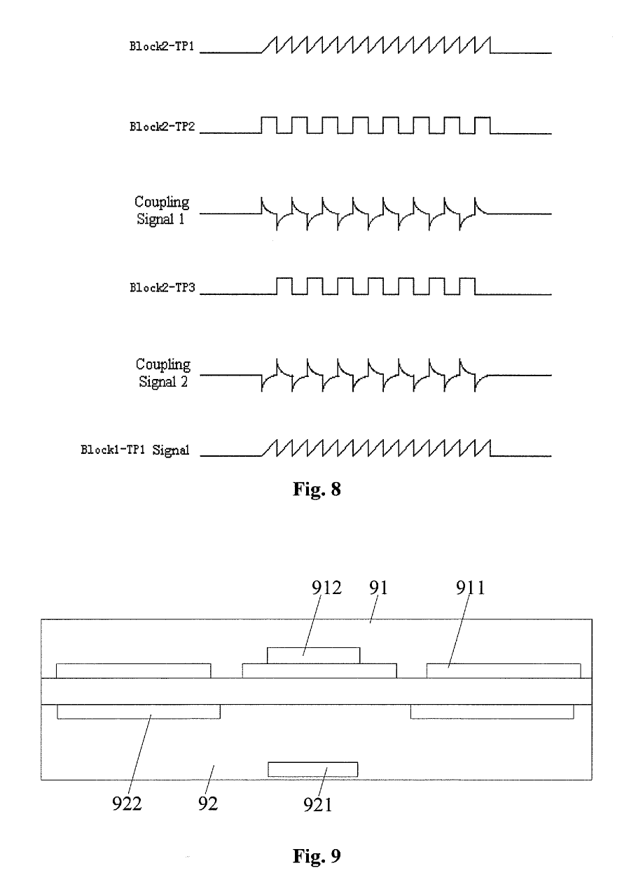

FIG. 9 is a sectional view of a substrate of a touch display according to an embodiment of the present disclosure. As shown in FIG. 9, a plurality of electrodes 911 are provided on a first substrate 91 at an interval, and a second substrate 92 is provided with data lines 921 arranged in the electrode column direction and pixel electrodes 922 arranged apart from one another. The projection locations of the metallic wires 912 and data lines 921 on the substrate plane correspond to each other to effectively reduce a size of a wiring region and ensure an aperture ratio of the display panel.

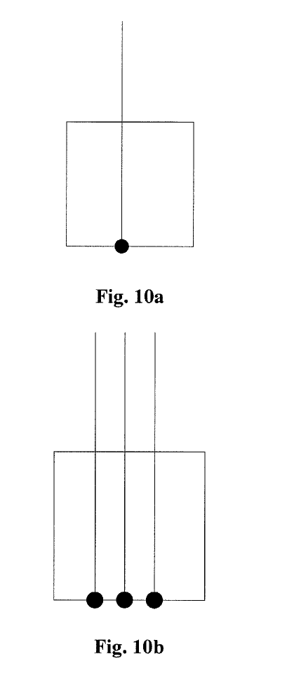

In addition, to implement precise control of the electrodes by the control unit, in the electrode structure as shown in FIG. 3 or FIG. 6, each electrode is connected to the control unit via one or more metallic wires. For example, as shown in FIG. 10a, each electrode may be connected to the control unit via one metallic wire, which may minimize the size of the wiring region. Alternatively, as shown in FIG. 10b, each electrode may be connected to the control unit via three metallic wires, so as to effectively ensure stability of signal transmission. Of course, the foregoing is only for illustration purpose, and not for restriction purpose. The number of the metallic wires may be selected as appropriate in an actual application.

In the above descriptions, individual small blocks shown in FIG. 3 or FIG. 6 are described as electrodes. As is known, these electrodes should be understood as “touch electrodes”, each of which may correspond to a single common electrode or a combination of a plurality of common electrodes in the in-cell touch display panel application.

Such a touch driving scheme in which the in-cell touch display structure is driven on a region basis achieves an effect of driving display and touch control at the same time, solves problems with the display and touch control caused by insufficient time due to time-division driving in a high resolution application, and effectively avoids an impact exerted by noises resulting from the signal coupling of the touch electrode to the display touch effect.

Those having ordinary skill in the art may appreciate that all or partial steps of the above embodiments may be implemented by hardware or implemented by a program instructing relevant hardware. The program may be stored in a computer-readable storage medium. The storage medium may be a read-only memory, a magnetic disk, an optical disk or the like. In addition, although operations are depicted in a specific order in the accompanying drawings, it does not mean that these operations must be performed in the shown specific order or in a sequential order, and that all the shown operations must be performed to obtain a desired result.

The foregoing are only preferred embodiments of the present disclosure and are not intended to limit the present disclosure. Any modifications, equivalent substitutions and improvements made within the spirit and principle of the present disclosure should be encompassed in the protection scope of the present disclosure.

1. A touch display drive method, comprising:
inputting a display drive signal and a touch scanning signal to an electrode array, the electrode array comprising:
at least one first electrode region and at least one second electrode region, wherein each of the first electrode region and second electrode region comprising a plurality of columns of electrodes, wherein each electrode in the plurality of columns of electrodes being provided with the display drive signal or touch scanning signal via a respective signal line in a column direction,
wherein the touch scanning signal is input to said at least one second electrode region for touch scanning while the display drive signal is being input to said at least one first electrode region for display driving, wherein each of respective signal lines provides the touch scanning signal generating a coupling signal with electrodes in the same column other than the electrode to which the touch scanning signal is provided via the signal line, and wherein the coupling signals generated by two of said signal lines that correspond to the electrodes in the same column offsetting each other; and
wherein the touch scanning signal is input to said at least one first electrode region for touch scanning while the display drive signal is being input to said at least one second electrode region for display driving, wherein each of respective signal lines providing the touch scanning signal generating a coupling signal with electrodes in the same column other than the electrode to which the touch scanning signal is provided via the signal line, and wherein the coupling signals generated by two of said signal lines that correspond to the electrodes in the same column offsetting each other.

2. The touch display drive method according to claim 1, wherein the electrode region comprises: at least one sub-region, wherein each sub-region comprises two adjacent rows of electrodes, and wherein the inputting of the touch scanning signal to the electrode region for touch scanning comprises:
inputting touch scanning signals with a same amplitude and different phases respectively to two electrodes in each column in each sub-region of the electrode region.

3. The touch display drive method according to claim 2, wherein said touch scanning signals with different phases are opposite phases.

4. The touch display drive method according to claim 1, wherein the electrode region comprises: at least one sub-region, wherein each sub-region comprising three adjacent rows of electrodes, and wherein the inputting of the touch scanning signal to the electrode region for touch scanning comprises:
while inputting the touch scanning signal to one of three electrodes in each column in each sub-region in the electrode region, inputting touch scanning signals with a same amplitude and different phases respectively to remaining two electrodes.

5. The touch display drive method according to claim 4, wherein said touch scanning signals with different phases have opposite phases.

6. The touch display drive method according to claim 1, wherein each electrode in the electrode array corresponds to a single common electrode or a combination of a plurality of common electrodes in an in-cell touch display screen.

7. A touch display drive device comprising a control unit, the control unit configured to:
input a display drive signal and a touch scanning signal to an electrode array, the electrode array comprising at least one first electrode region and at least one second electrode region, each of the first electrode region and second electrode region comprising a plurality of columns of electrodes, and each electrode in the plurality of columns of electrodes being provided with the display drive signal or touch scanning signal via a respective signal line in a column direction,
wherein the control unit is configured to input the touch scanning signal to said at least one second electrode region for touch scanning while inputting the display drive signal to said at least one first electrode region for display driving, each of respective signal lines providing the touch scanning signal generating a coupling signal with electrodes in the same column other than the electrode to which the touch scanning signal is provided via the signal line, and the coupling signals generated by two of said signal lines that correspond to the electrodes in the same column offset each other; and
wherein the control unit is configured to input the touch scanning signal to said at least one first electrode region for touch scanning while inputting the display drive signal to said at least one second electrode region for display driving, each of respective signal lines providing the touch scanning signal generating a coupling signal with electrodes in the same column other than an electrode to which the touch scanning signal is provided via the signal line, and the coupling signals generated by two of said signal lines that correspond to the electrodes in the same column offsetting each other.

8. The touch display drive device according to claim 7, wherein the electrode region comprises at least one sub-region, each sub-region comprising two adjacent rows of electrodes, and wherein the control unit is further configured to input touch scanning signals with a same amplitude and different phases to two electrodes in each column in each sub-region of the electrode region.

9. The touch display drive device according to claim 8, wherein said touch scanning signals with different phases have opposite phases.

10. The touch display drive device according to claim 7, wherein the electrode region comprises at least one sub-region, each sub-region comprising three adjacent rows of electrodes, and wherein the control unit is further configured to input the touch scanning signal to one of three electrodes in each column in each sub-region of the electrode region while inputting touch scanning signals with a same amplitude and different phases respectively to remaining two electrodes.

11. The touch display drive device according to claim 10, wherein said touch scanning signals with different phases have opposite phases.

12. The touch display drive device according to claim 7, wherein each electrode in the electrode array corresponds to a single common electrode or a combination of a plurality of common electrodes in an in-cell touch display screen.

13. A touch display device, comprising:
a first substrate and a second substrate formed by cell-assembling, the first substrate being provided with an electrode array; and
a touch display drive device according to claim 7, the touch display drive device being electrically connected with each electrode in the electrode array respectively via a respective metallic wire.

14. The touch display device according to claim 13, wherein the second substrate is provided with a data line arranged in a column direction of the electrode array, and projection locations of the metallic wire and the data line on a substrate plane correspond to each other.

15. The touch display device according to claim 13, wherein each electrode is connected with the control unit via one or more metallic wires.

16. The touch display drive method according to claim 2, wherein each electrode in the electrode array corresponds to a single common electrode or a combination of a plurality of common electrodes in an in-cell touch display screen.

17. The touch display drive method according to claim 4, wherein each electrode in the electrode array corresponds to a single common electrode or a combination of a plurality of common electrodes in an in-cell touch display screen.

18. The touch display drive device according to claim 10, wherein each electrode in the electrode array corresponds to a single common electrode or a combination of a plurality of common electrodes in an in-cell touch display screen.

19. The touch display drive device according to claim 11, wherein each electrode in the electrode array corresponds to a single common electrode or a combination of a plurality of common electrodes in an in-cell touch display screen.

20. The touch display drive device according to claim 12, wherein each electrode in the electrode array corresponds to a single common electrode or a combination of a plurality of common electrodes in an in-cell touch display screen.
